(19) United States
(12) Patent Application Publication
(10) Pub. No.: US 2010/0208959 A1
(43) Pub. Date: Aug. 19, 2010

(54) METHOD FOR MANAGING AND/OR PROCESSING MEDICAL IMAGE DATA

(76) Inventors: Antonius AX, Effeltrich (DE); Karlheinz Dorn, Kalchreuth (DE); Andrew John Hewett, Erlangen (DE); Vladyslav Ukis, Nurnberg (DE)

Correspondence Address: HARNESS, DICKEY & PIERCE, P.L.C., P.O.BOX 8910, RESTON, VA, 20195, US

(21) Appl. No.: 12/706,283

(22) Filed: Feb. 16, 2010

(30) Foreign Application Priority Data
Feb. 18, 2009 (DE) 10 2009 009 385.0

(51) Int. Cl. G06K 9/00

(52) U.S. Cl. 382/128

(57) ABSTRACT

A method for managing and/or processing medical image data is disclosed, in particular for controlling a medical workflow. Furthermore, a computer system and a computer program product having a computer program product code for implementing the method are disclosed. One embodiment is directed to a method for managing and/or processing medical image data including inputting medical image data generated by one or several modalities, the image data including the description data according to a predefined structure; assigning the image data to a template as a function of the classification thereof, with the template specifying the respective processing of image data in one or several processing steps and being used for the classification preferably of lists of classification criteria; and extracting the classification criteria at least partially from the description data.

### PRIORITY STATEMENT

The present application hereby claims priority under 35 U.S.C. §119 on German patent application number DE 10 2009 009 385.0 filed Feb. 18, 2009, the entire contents of which are hereby incorporated herein by reference.

### FIELD

At least one embodiment of the invention generally relates to a method for managing and/or processing medical image data, in particular for controlling a medical workflow. Furthermore, at least one embodiment of the invention generally relates to a computer system and to a computer program product having a computer program code for implementing the method.

### BACKGROUND

The publication DE 101 25 504 B4 discloses a method and a computer system for workflow management, which is shown in the upper part of FIG. 1 as a method for DICOM image-based mapping (assignment) of taskflow templates. A workflow and/or taskflow describes cycles and/or the operation of different tasks. Within the field of IT technology, a template specifies certain workflows and/or taskflows, which can be reused and/or repeated for different applications.

Medical modalities such as CT and MR devices are shown in detail on the inner ring M in FIG. 1. These implement so-called exams, which are intended to produce DICOM images of the patient organs. Within the field of medicine, DICOM (Digital Imaging and Communications in Medicine) is prevalent as an open standard for exchanging information. The term “exam” is understood to mean the actual examination on the modality, while a “postprocessing” indicates the subsequent processing and interpretation of the image data generated with the modality.

Once the images have been recorded, they are sent to the external ring P in FIG. 1. They are used there by postprocessing workstations (WS) for a so-called reading or patient findings.

The afore-cited method discloses how the individual postprocessing steps, which are to be implemented by users U, generally physicians, can be specified in the form of a taskflow template. Different taskflow templates are prepared here for different image types. When introducing an image into a postprocessing system, the image is analyzed and classified on the basis of its image header parameter. A taskflow template is assigned in accordance with this classification (e.g. CT neck image, MR leg image) and the user is guided by the steps specified in the template in order to implement the finding. The taskflow template therefore controls the post-processing process in hospital.

The known taskflow templates describe postprocessing steps, which are to be implemented by the physicians. Taskflow template mapping is currently implemented on a DICON image basis. When receiving an image, its header is analyzed, a corresponding taskflow template is assigned and its processing is activated. The afore-cited prior art nevertheless does not describe a method, with which it would be possible to implement a taskflow template mapping which assumes the control of the exam processes (prior to postprocessing). This results in exam processes proceeding in an uncontrolled manner and thus potentially being faulty. Different physicians may implement the processes differently. This also fails to ensure that exam processes are attuned to the subsequent postprocessing processes so that a correct finding is implemented at the end of the processing chain.

### SUMMARY

In at least one embodiment of the invention, the afore-cited procedure in respect of controlling exam processes is improved.

One aspect of at least one embodiment of the invention is a method for managing and/or processing medical image data having the following steps:
Inputting medical image data generated by one or several modalities, said image data comprising description data according to a predefined structure (for instance modality worklist),
Assigning the image data, preferably by means of a so-called taskflow template mapper MP) to a template as a function of the classification thereof (e.g. task template respository R), with the template specifying the respective processing of image data in one or several processing steps and being used for the classification preferably of lists of classification criteria,
characterized in that the classification criteria are extracted at least partially from the description data.

In particular, at least one embodiment of the inventive method is used to control a medical workflow.

An output file which corresponds to the template and has data for identifying the processing steps is preferably generated.

The classification is expediently implemented in a rule-based fashion on the basis of the said classification criteria.

Processing steps could be grouped here on the basis of the extracted description data.

A further aspect of at least one embodiment of the invention is a computer system for implementing the method as claimed in one of the inventive method steps, comprising

means for classifying image data, which comprise description data according to a predefined structure,

means for assigning image data to a template as a function of the classification, with the template specifying the respective processing of image data in one or several processing steps, characterized by

means for extracting classification criteria from the description data.

Furthermore, the computer system can comprise means for generating an output file which corresponds to the template and has data for identifying the processing steps.

A further aspect of at least one embodiment of the invention is a computer program product having a computer program code for implementing the method steps of the inventive method, with the computer program code being executed on a computer, in particular on the computer system according to one of the preceding apparatus designs.

A further aspect of at least one embodiment of the invention is that the computer program code of the computer program product is stored on a medium which can be read by a computer.

At least one embodiment of the invention is characterized by at least one of the following advantages.
The inventive approach of at least one embodiment makes it possible to specify and to start taskflow templates, which include both exam and also postprocessing processes.
A predefined and structured procedure is specified when implementing the exam (by exam tasks in task flows).
The inventive approach of at least one embodiment enables the standardization of procedures (which contributes to the consistent use of optimal methods within a department of a hospital and/or clinic or similarly organized medical practice).
The inventive approach of at least one embodiment is helpful for the correct calculation of standard methods (e.g. it may be that certain steps of a complex taskflow template are only provided by private hospitals).
Optimal adjustment of implemented exams and postprocessing steps within the scope of a taskflow is possible, i.e.
   Prevention of non-uniformly implemented exam processes, which are superfluous or unsuited to the postprocessing steps provided.
   Prevention of postprocessing analyses by physicians in hospital, which are not (optimally) suited to the previously implemented exams.
Chronological optimization of the workflow in hospital by grouping processes.

### BRIEF DESCRIPTION OF THE DRAWINGS

An example embodiment of the invention is explained in more detail below with reference to a drawing, in which;

FIG. 1 shows an image-based assignment (mapping) of at least one taskflow template,

FIG. 2 shows an example so-called DICOM modality worklist (a work list of modalities),

FIG. 3 shows the inventive procedure in respect of the said taskflow template mapping,

FIG. 4 shows an exemplary temporal operation of an embodiment of the inventive procedure,

FIG. 5 shows an example architecture for an embodiment of the inventive procedure,

FIG. 6 shows an example user interface for assigning taskflow templates and

FIG. 7 shows example (parameter) settings for an embodiment of the inventive assignment.

FIG. 8 shows an additional example of procedure grouping during taskflow template mapping.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In accordance with an embodiment of the invention, taskflow templates are proposed, which not only describe postprocessing steps, but also contain exam processes. Furthermore, a taskflow template mapper MP is introduced, which is able to promptly assign the new taskflow templates, i.e. even before starting the exams. An embodiment of the inventive mapper is thus able to control larger workflows, which contain both exam and also postprocessing processes.

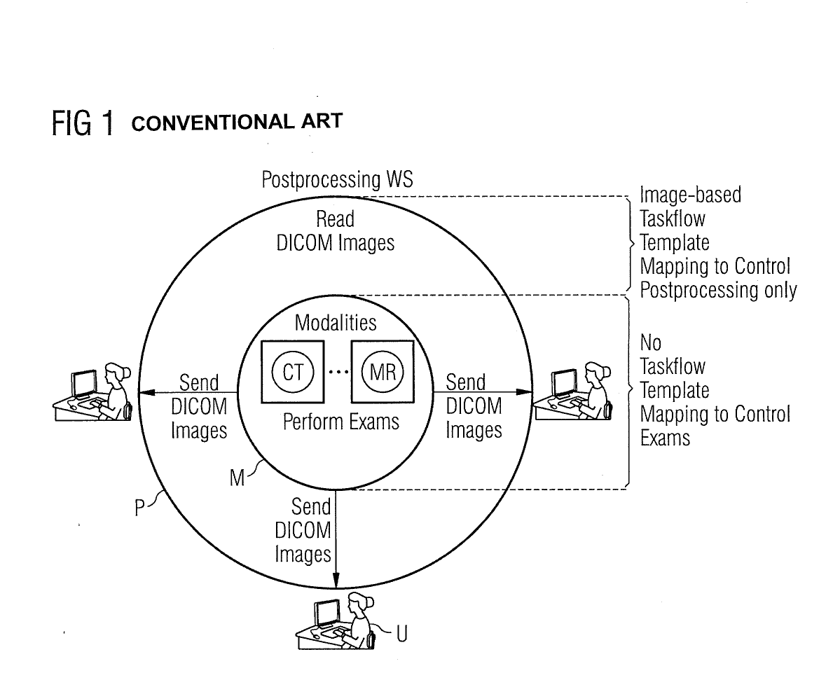

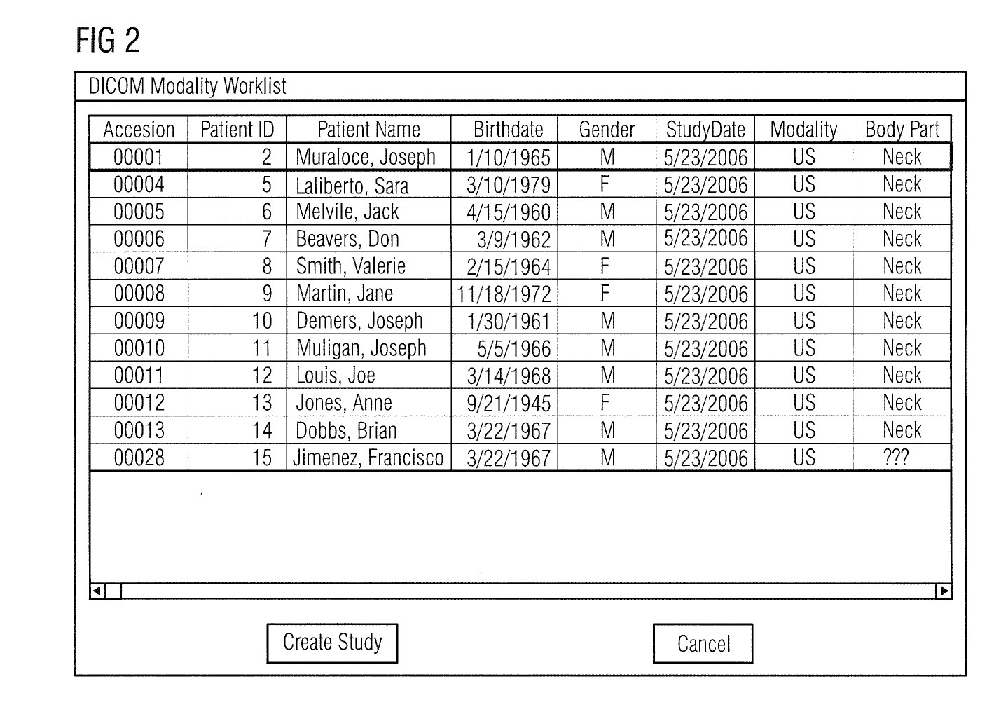

In respect of modalities on the inner ring M of FIG. 1, exams are generally geared mostly toward the so-called DICOM modality worklists. One example of a DICOM modality worklist is shown in FIG. 2.

The DICOM modality worklist in FIG. 2 contains several items of patient data with details of examinations, which are to be implemented on a modality for the patients. For instance, a male patient “Muraloce, Joseph” is specified in the first line from above. He requires a “neck” examination (or exam) on an ultrasound (US) device.

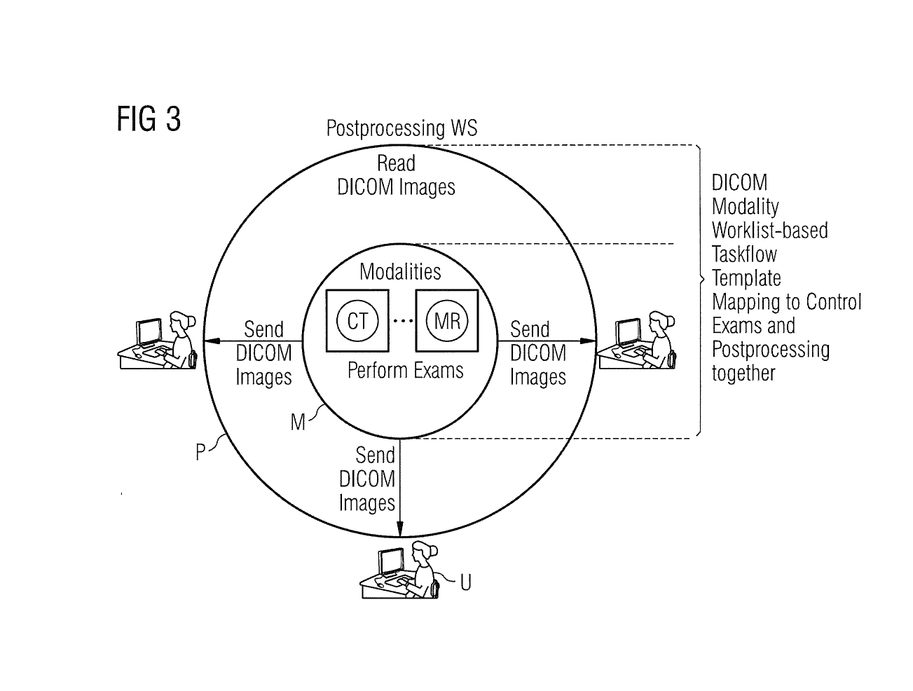

DICOM modality work lists can be used as a basis for taskflows, which control both exam and also postprocessing processes. A DICOM modality worklist contains all demographic patient data needed therefor as well as details relating to the modality examinations to be implemented and desired findings. Protocols can proceed in an exam corresponding to a taskflow on the basis of the data in the DICOM modality worklist (e.g. “US Neck Exam for Men”) and suitable postprocessing steps can subsequently be implemented (e.g. “2D Viewing US Neck” and “Create Report US Neck”). The mapping (assignment) of these comprehensive taskflow templates is illustrated in FIG. 3.

FIG. 3 shows that a DICOM modality worklist-based taskflow template is assigned in order to control both exams and also postprocessing processes. The advantages of such comprehensive taskflow template mappings are inter alia as follows:
Predefined and structured procedure when implementing the exams,
Elimination of the exam processes, which are implemented non-uniformly in hospital
Precise harmonization of the implemented exams with postprocessing steps
Elimination of the postprocessing analyses by physicians in hospital, which are not optimally suited to the previously implemented exams.

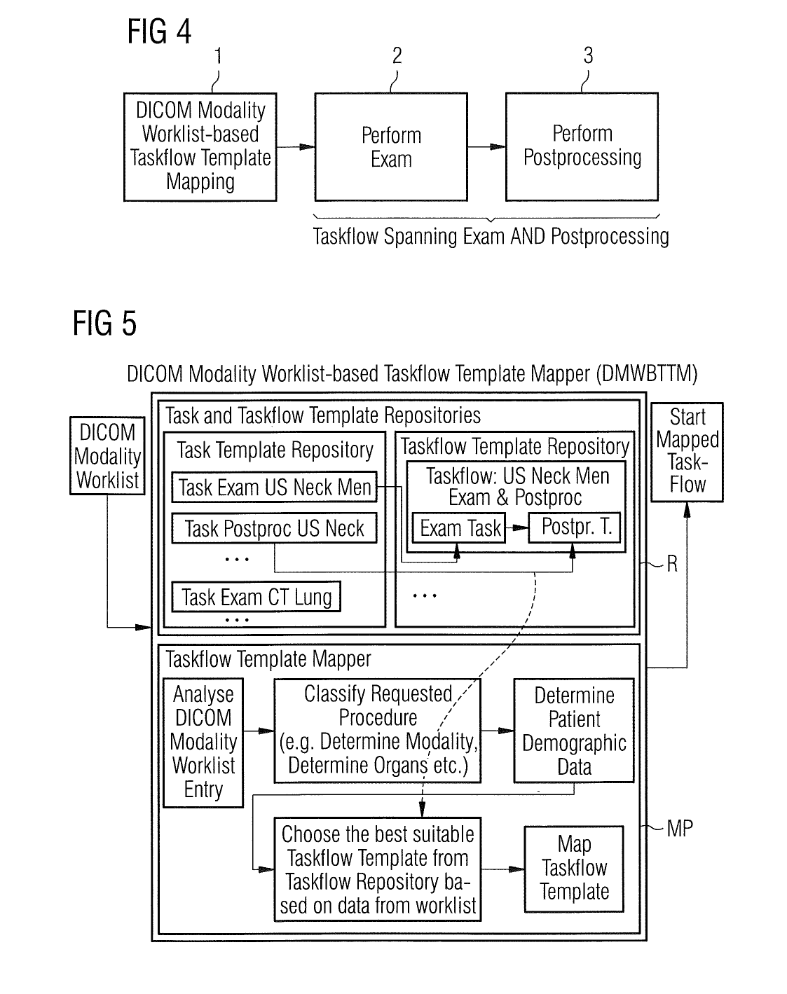

FIG. 4 shows an exemplary temporal course of the taskflow mappings. The taskflow mapping 1 is assigned before exam processes 2 and subsequently postprocessing processes 4 are implemented. An assigned taskflow specifies both exam and also postprocessing steps. The mapping of the taskflow template is implemented by a so-called DICOM modality worklist-based taskflow template mapper, which is illustrated in FIG. 5.

The mapper MP in FIG. 5 receives a DICOM modality worklist as an input for a patient (e.g. a line according to FIG. 2). It contains functionalities in order to implement an optimal taskflow template mapping so that a mapped taskflow can be started as an output on the right side of FIG. 5.

The architecture in FIG. 5 for the inventive procedure essentially consists of two parts:

1. Task and taskflow template repositories R

2. Taskflow template mapper MP

The task template respository in the left upper part of FIG. 5 consists of individual task templates. Both exam and also processing task templates can be found therein. The task templates in the task template repository are not connected to one another. This is advantageous in that a task template from the task template repository can be used in several taskflow templates.

The taskflow template repository in the right upper part of FIG. 5 contains taskflow templates. A taskflow template is produced by interconnecting the individual task templates from the task template repository. The interconnection can take place by configuring the task ports for mutual data exchange purposes. A taskflow template “US Neck Men Exam & Postproc” is an example in the Figure. This taskflow template is used to control ultrasound exams and postprocessing. The taskflow template is generated by taking an exam task and a postprocessing task from the task template repository and interconnecting them together by means of configuration. The finished taskflow templates are used by the taskflow template mapper shown in the lower part of FIG. 5.

The taskflow template mapper functions according to the following algorithm. The mapper firstly analyses the DICOM modality worklist entered at the input. It extracts the information concerning
the clinical problems and examination methods (e.g.: modality, indication, requested procedure description, procedure code, body parts examined, protocol code)
necessary demographic patient data (e.g.: sex, age, medical insurance, private or covered by a public heath insurance plan, height/weight)
medical data (e.g.: allergies, medication, contraindications)

Based on this information, the taskflow template mapper examines the taskflow template repository and attempts to find a taskflow template which corresponds to the criteria extracted from the DICOM modality worklist.

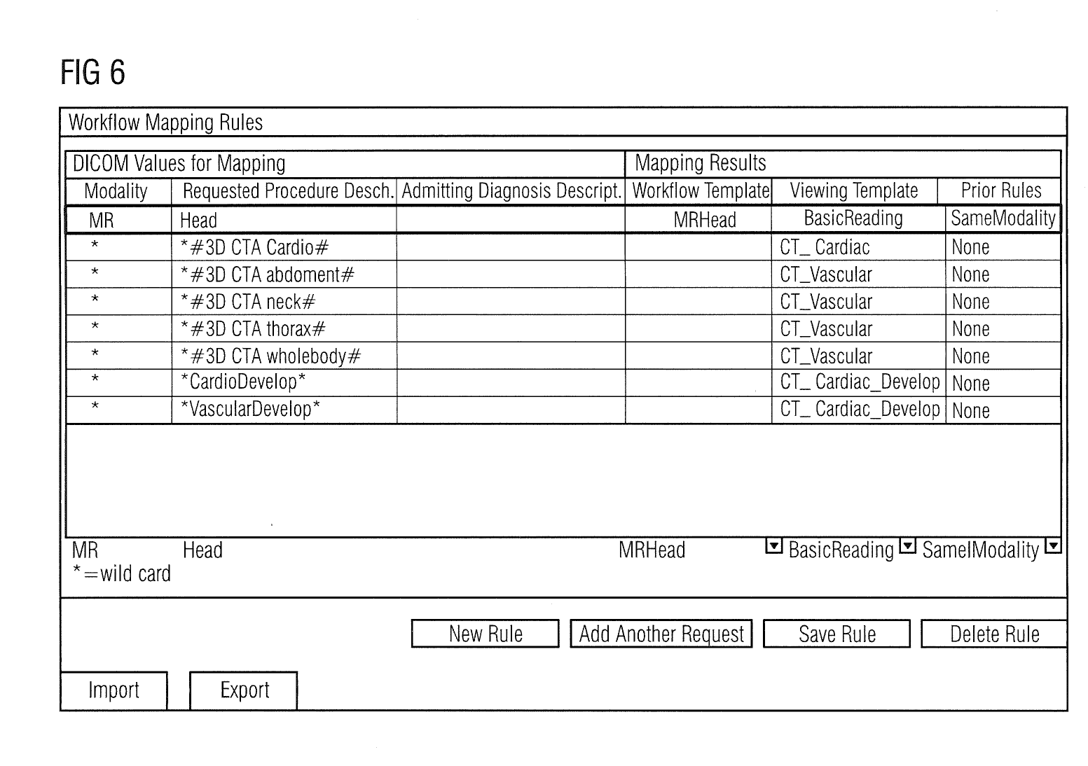

Upon discovery of a suitable taskflow template, the taskflow template mapper assigns the template in the system. It is thus known within the system and can be started in order to control the exam and postprocessing processes. In this connection, the correspondence of the parameter from the DICOM modality worklist to the taskflow template can be configured. The configuration is generally site-specific (location-dependent). It normally depends on which procedure catalogue is offered by the respective “imaging” department. The configuration is processed by a so-called knowledge-based rules engine. The user interface for configuring the rules, according to which the assignment of the taskflow templates is to take place, is illustrated in FIG. 6. A workflow mapping rule is selected in FIG. 6, said workflow mapping rule assigning the MR head images to the workflow template “MRHead”. It is also specified that if such images of the user are viewed in detail and independently of the DICOM modality worklist, a viewing template “BasicReading” (a template for inspection) is to be used. Furthermore, it is specified that the prioritized rule “Same Modality” is to be used. This rule means that the workflow “MRHead” will not only process the current images of the affected patient but instead all MR images of the patient which were recorded in a configurable time frame (e.g. the last 12 months). Technically this is activated by an asynchronous job. Current images are firstly processed and if the asynchronous job is finished, earlier MR images are shown.

The following prioritized rules are supported:
“SameModality”—images of the same modality—as specified by “modality” in FIG. 6—of the same patient, which are currently being examined, are processed,
“SamePatient”—images of the same patient, which are currently being examined, are processed,
“SameRPDescription”—images with the same requested procedure of the same patient of the same patient, which are currently being examined, are processed,
“SameModalityAndRPDescription”—images of the same modality—as specified with “modality” in FIG. 6 and with the same requested procedure—of the same patient of the same patient, which are currently being examined, are processed.

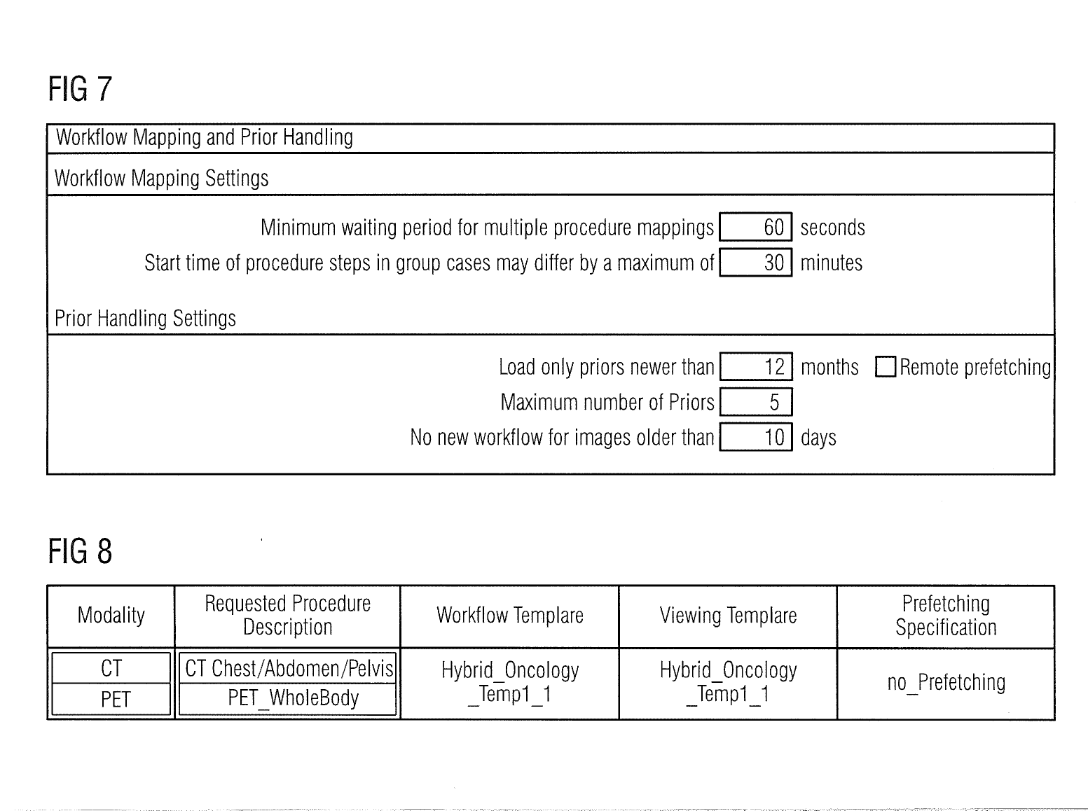

A further advantage of an embodiment of the invention resides in a 1:1 assignment of requested procedure to task flow template not always taking place. Instead, attempts are made to group associated processes and/or procedures and to assign the group to a single highly-specialized taskflow template (N:1 mapping). A configuration for this is illustrated in the top part of FIG. 7.

A grouping takes place for procedures of a patient. This reduces the time taken to process the procedure. As a grouped specialized taskflow can be processed more quickly, it is possible for each procedure to be processed as an individual task flow. For instance, a special taskflow template can exist for MR head and lungs. It is assigned for two requested procedures “MR Head” and “MR Lung”, instead of assigning two individual taskflow templates.

An additional example of procedure grouping during taskflow template mapping is shown in FIG. 8.

All procedures “CT Chest/Abdomen/Pelvis” and “PET_WholeBody” of a patient are combined and mapped onto the workflow template “Hybrid_Oncology_Templ_{—}1”. It should be highlighted that in this case the workflow template can even process images of two different modalities.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for at least one of managing and processing medical image data, comprising:
inputting medical image data generated by one or several modalities, the medical image data comprising description data according to a defined structure;
assigning the input medical image data to a template as a function of a classification of the input medical image data, the template specifying a respective processing of image data in one or several processing steps and being used for the classification of lists of classification criteria,
the classification criteria being extracted at least partially from the description data.

2. The method as claimed in claim 1, further comprising:
generating an output file which corresponds to the template and has data for identifying the processing steps.

3. The method as claimed in claim 1, wherein classification is implemented in a rule-based fashion on the basis of said classification criteria.

4. The method as claimed in claim 1, wherein the processing steps are grouped on the basis of the extracted description data.

5. A computer system, comprising
means for classifying image data, the image data including description data according to a defined structure;
means for assigning the image data to a template as a function of the classification, the template specifying respective processing of the image data in one or several processing steps; and
means for extracting classification criteria from the description data.

6. The computer system as claimed in claim 5, further comprising:
means for generating an output file which corresponds to the template and includes data for identifying the processing steps.

7. A computer program product comprising:
a computer program code for implementing the method of claim 1, upon the computer program code being executed on a computer system.

8. The computer program product as claimed in claim 7, wherein the computer program product is stored on a medium which can be read by a computer.

9. A computer readable medium including program segments for, when executed on a computer device, causing the computer device to implement the method of claim 1.
